(19) United States
(12) Patent Application Publication
(10) Pub. No.: US 2010/0231409 A1
(43) Pub. Date: Sep. 16, 2010

(54) COMMUNICATION CONTROLLER CIRCUIT FOR CONTROLLING CONTROLLED UNITS

(76) Inventors: Shinichi Okada, Osaka (JP); Yasuo Oba, Shiga (JP); Hidehiko Kurimoto, Hyogo (JP); Seiichi Muroya, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/293,677

(22) PCT Filed: Mar. 23, 2007
(86) PCT No.: PCT/JP2007/056030

§ 371 Date: Sep. 19, 2008

(30) Foreign Application Priority Data
Mar. 23, 2006 (JP) 2006-080293

(51) Int. Cl. H04Q 3/42

(52) U.S. Cl. 340/825.21

(57) ABSTRACT

A communication control circuit includes a shift register and a control data selector, and controls controlled units according to a data signal, a clock signal and a strobe signal inputted via three serial signal lines. The shift register serial-to-parallel converts the data signal sequentially taken in according to the clock signal into a converted signal, and outputs the converted signal. The control data selector selects control data for controlling the corresponding controlled unit from the signal from the shift register, in response to a device definition signal for identifying the communication control circuit, and outputs the same control data.

### TECHNICAL FIELD

The present invention relates to a communication control circuit and method, and a communication system and an electronic apparatus employing the same communication system for controlling a plurality of controlled units. In particular, the present invention relates to a communication control circuit and method, and a communication system and an electronic apparatus employing the same communication system for controlling a plurality of controlled units using signals inputted from host controller means via three serial signal lines.

### BACKGROUND ART

In recent years, a diversity receiving method has been proposed as a method for improving the receiving performance of a car navigation system apparatus and a mobile communication apparatus as represented by a mobile phone. In particular, tuners of at least two systems are required in order to constitute a diversity receiving system for a carrier synthesis system. Generally speaking, in such a system, an IC chip is used for each tuner, and the IC chip for tuner normally requires a selector gate, a switch circuit, a latch circuit for holding the set conditions and set values and so on, in order to perform switchover of the circuit functions and performance, respectively. The set conditions and set values held in the latch circuit are set from the host controller means by serial communications. Accordingly, the host controller means needs to control a plurality of IC chips individually. In addition, in the mobile communication apparatus represented by the mobile phone, the IC chip for tuner has been demanded to be more downsized, and the time required for controlling the IC chip is required to be shortened as far as possible, since the IC chip for tuner should be controlled following the temporal changes in the receiving state.

Accordingly, Patent Document 1 discloses a serial interface circuit of a first prior art example for reducing the number of signal lines for an interface, and for preventing the transmission time from increasing in a digital circuit in which a plurality of serial devices each having a serial interface of three-line system are mounted. In the serial interface circuit of the first prior art example, a controlled device selector section takes in a selection signal transmitted via a first signal line according to a clock and a strobe signal via fourth and fifth signal lines, and outputs “1” to a corresponding selector.

Subsequently, when input data is outputted from a control section via the first signal line and a clock is outputted from the control section via a second signal line, each of the controlled devices once latches the input data. In addition, a strobe signal via a third signal line is set to pass through the selector to which “1” is transmitted from the controlled device selector section, and only the corresponding controlled device is set to take in the input data. During data output from the controlled device, a data output device selector section selects corresponding data according to a signal from the controlled device selector section, and outputs the data to a sixth signal line.

In addition, Non-Patent Document 1 discloses a serial communication system according to a second prior art example employing an I²C bus. In the serial communication system according to the second prior art example, the number of signal lines are reduced by controlling a plurality of slave apparatuses connected to a master apparatus via a serial data line and a serial clock line from the master apparatus.

Patent Document 1: Japanese patent laid-open publication No. JP-2000-259559-A (FIG. 1).

Non-Patent Document 1: The I²C-bus specification, Version 2.1, Philips Semiconductors, January, 2000.

### DISCLOSURE OF THE INVENTION

### Problems to be Solved by the Invention

However, the serial interface circuit of the first prior art example has such a problem that it is difficult to shorten the communication time for serial communication since it is required to send data from the control section to the controlled device selector section firstly before data for controlling the controlled devices is sent, upon controlling the controlled devices from the control section.

In addition, the serial communication system of the second prior art example has such a problem that it is difficult to shorten the communication time for serial communication since it is required to transmit address data of slave apparatuses and data of the slave apparatuses in order to control slave apparatuses, and a procedure for the communications is complicated.

It is an object of the present invention to provide a communication control circuit and method, and a communication system and an electronic apparatus employing the same communication system each capable of solving the above-mentioned problems and capable of shortening the communication time for serial communication without increasing the number of the wirings of the serial signal lines by using signals inputted from host controller means via three serial signal lines.

### Means for Solving the Problems

According to the first aspect of the present invention, in a communication control circuit for controlling a plurality of controlled units according to a data signal, a clock signal and a strobe signal inputted via three serial signal lines, the data signal includes control data for controlling at least one of the plurality of controlled units. The communication control circuit includes a shift register for sequentially taking in the data signal according to the clock signal, serial-to-parallel converting the data signal into a converted data signal, and outputting the converted data signal, and control data selector means for selecting and outputting control data for controlling a corresponding controlled unit from the converted data signal from the shift register, in response to an inputted device definition signal for identifying the communication control circuit.

In the above-mentioned communication control circuit, the data signal preferably further includes latch selection data. The communication control circuit preferably further includes data latch selector means for comparing the latch selection data with an inputted data latch definition signal for identifying the controlled units, and outputting a signal indicating a comparison result, and data latch means. The data latch means (a) holds the control data of the converted data signal from the shift register and outputting the control data to the control data selector means based on the inputted strobe signal when the signal indicating the comparison result indicates that the latch selection data and the inputted data latch definition signal coincide with each other, and (b) stops holding the control data of the converted data signal from the shift register when the signal indicating the comparison result indicates that the latch selection data and the inputted data latch definition signal do not coincide with each other.

According to the second aspect of the present invention, a communication control system having a plurality of above-mentioned communication control circuits includes host controller means for generating the data signal, the clock signal and the strobe signal, and transmitting the data signal, the clock signal and the strobe signal to the plurality of communication control circuits via the three serial signal lines.

According to the third aspect of the present invention, an electronic apparatus includes the above-mentioned communication control system.

According to the fourth aspect of the present invention, in a communication control method for controlling a plurality of controlled units according to a data signal, a clock signal and a strobe signal inputted via three serial signal lines, the data signal includes control data for controlling at least one of the plurality of controlled units. The communication control method includes the following steps of sequentially taking in the data signal according to the clock signal, serial-to-parallel converting the data signal into a converted data signal, and outputting the converted data signal, and selecting and outputting control data for controlling a corresponding controlled unit from the converted data signal, in response to an inputted device definition signal for identifying the communication control circuit.

In the above-mentioned communication control method, the data signal preferably further includes latch selection data. The communication control method preferably further includes the following steps of (a) comparing the latch selection data with an inputted data latch definition signal for identifying the controlled units, and outputting a signal indicating a comparison result, (b) holding the control data of the converted data signal and outputting the control data to the control data selector means based on the inputted strobe signal when the signal indicating the comparison result indicates that the latch selection data and the inputted data latch definition signal coincide with each other, and (c) stopping holding the control data of the converted data signal when the signal indicating the comparison result indicates that the latch selection data and the inputted data latch definition signal do not coincide with each other.

### EFFECTS OF THE INVENTION

Therefore, each of the communication control circuit and method, and the communication system and the electronic apparatus employing the same communication system according to the present invention has control data selector means for selecting and outputting the control data for controlling the corresponding controlled unit from the converted data signal from the shift register, in response to the inputted device definition signal for identifying the communication control circuit. Accordingly, it is possible to shorten the communication time for serial communication without increasing the number of the wirings of the serial signal lines by using signals inputted from host controller means via three serial signal lines.

### BRIEF DESCRIPTION OF THE DRAWINGS

FIG. 1 is a block diagram showing a configuration of a communication system according to a preferred embodiment of the present invention;

FIG. 2 is a block diagram showing a detailed configuration of a data control circuit 126 of a communication control circuit 102 of FIG. 1;

FIG. 3 is a timing chart showing signals transmitted to the communication control circuits 102 and 103 of FIG. 1;

FIG. 4 is a table showing one example of a configuration of a data signal DAT of FIG. 3;

FIG. 5 is a block diagram showing configurations of a shift register 121 of the communication control circuit 102 of FIG. 1, and a data latch selector 122 and a data latch circuit 123 of FIG. 2;

FIG. 6 is a circuit diagram showing a detailed configuration of a control data selector 124 of FIG. 2; and

FIG. 7 is a block diagram showing a configuration of a mobile phone 1 employing the communication system of FIG. 1.

### DESCRIPTION OF REFERENCE SYMBOLS

1 . . . Mobile phone,
2 to 6 . . . . Antenna,
7 . . . . Bluetooth wireless transceiver circuit,
8 . . . GPS wireless receiver circuit,
9 . . . Video and audio wireless transceiver circuit,
10 . . . Control section,
11 . . . Rechargeable battery,
12 . . . Power management circuit,
13 . . . Memory,
14 . . . SD memory card,
15 . . . Loudspeaker,
16 . . . Head-set,
17 . . . USB interface,
18 . . . Camera,
19 . . . Display,
20 . . . Tuner circuit
21 . . . OFDM demodulator circuit,
22 and 23 . . . . Tuner,
90 . . . Switch,
91 . . . Low noise amplifier (LNA),
92 . . . Power amplifier (PA),
93 . . . Voltage controlled oscillator (VCO) circuit,
94 . . . Phase locked loop (PLL) circuit,
95 . . . Frequency converter circuit,
96 . . . Baseband processing circuit,
97 . . . CPU,
101 . . . Host controller,
102 and 103 . . . Communication control circuit,
104 . . . Data selector,
105 and 106 . . . IC chip,
121 . . . Shift register,
122 . . . Data latch selector,
123 . . . Data latch circuit,
124 . . . Control data selector,
126 . . . Data control circuit,
127 . . . Controlled unit,
DAT . . . Data signal,
CLK . . . Clock signal,
CLAC . . . Data latch definition signal,
CDEV . . . Device definition signal,
STB . . . Strobe signal,
311 to 328 . . . Delayed flip-flop circuit, and
329 to 336 . . . . Selector.

### BEST MODE FOR CARRYING OUT THE INVENTION

A preferred embodiment according to the present invention will be described hereinafter with reference to the drawings. Components similar to each other are denoted by the same reference numerals.

### Preferred Embodiment

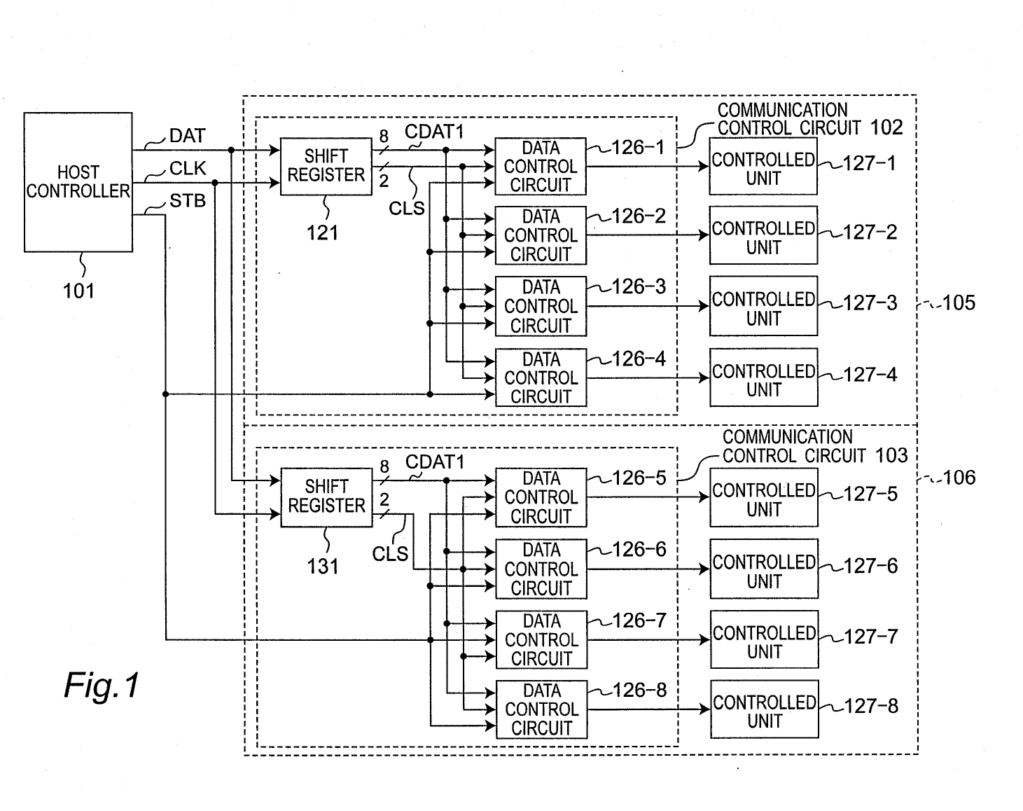

FIG. 1 is a block diagram showing a configuration of a communication system according to a preferred embodiment of the present invention. Referring to FIG. 1, the communication system is configured to include a host controller 101, communication control circuits 102 and 103, and controlled units 127-1 to 127-8. Each of the communication control circuits 102 and 103 is connected to the host controller 101, inputs thereto a data signal DAT, a clock signal CLK and a strobe signal STB from the host controller 101 via three serial signal lines. The communication control circuits 102 controls four controlled units 127-1 to 127-4 according to the respective inputted signals, and the communication control circuits 103 controls four controlled units 127-5 to 127-8 according to the respective inputted signals. The communication control circuit 102 and the controlled units 127-1 to 127-4 are formed on one IC chip 105, and the communication control circuit 103 and the controlled units 127-5 to 127-8 are formed on another IC chip 106.

The host controller 101 generates the data signal DAT, the clock signal CLK and the strobe signal STB, and transmits the generated signals to the communication control circuits 102 and 103 via the three serial signal lines.

The data signal DAT includes 8-bit control data for controlling the controlled units 127-1 to 127-8 connected to the communication control circuits 102 and 103, and 2-bit latch selection data.

The communication control circuit 102 is configured to include a shift register 121 and data control circuits 126-1 to 126-4. The shift register 121 sequentially takes in the data signal DAT, which is a serial signal including the control data and the latch selection data, according to the clock signal CLK, holds the data signal DAT, serial-to-parallel converts the data signal DAT into a control signal CDAT1 and a latch selection signal CLS, and outputs the control signal CDAT1 and the latch selection signal CLS to the data control circuits 126-1 to 126-4. In a manner similar to that of the communication control circuit 102, the communication control circuit 103 is configured to include a shift register 131 and data control circuits 126-5 to 126-8. The shift register 131 sequentially takes in the data signal DAT, which is the serial signal including the control data and the latch selection data, according to the clock signal CLK, holds the data signal DAT, serial-to-parallel converts the data signal DAT into the control signal CDAT1 and the latch selection signal CLS, and outputs the control signal CDAT1 and the latch selection signal CLS to the data control circuits 126-5 to 126-8.

Each of the data control circuits 126-1 to 126-4 and 126-5 to 126-8 selects a control signal corresponding to a controlled unit to control, from the control signal CDAT1 according to the control signal CDAT1 and the latch selection signal CLS from the shift register 121 or 131 and the strobe signal STB from the host controller 101. Then, the data control circuits 126-1 to 126-4 and 126-5 to 126-8 output the selected control signals to the controlled units 127-1 to 127-4 and 127-5 to 127-8, respectively, to control the controlled units 127-1 to 127-4 and 127-5 to 127-8, respectively. It is noted that the data control circuits 126-1 to 126-8 are generically called the data control circuit 126 and the controlled units 127-1 to 127-8 are generically called the controlled unit 127 hereinafter.

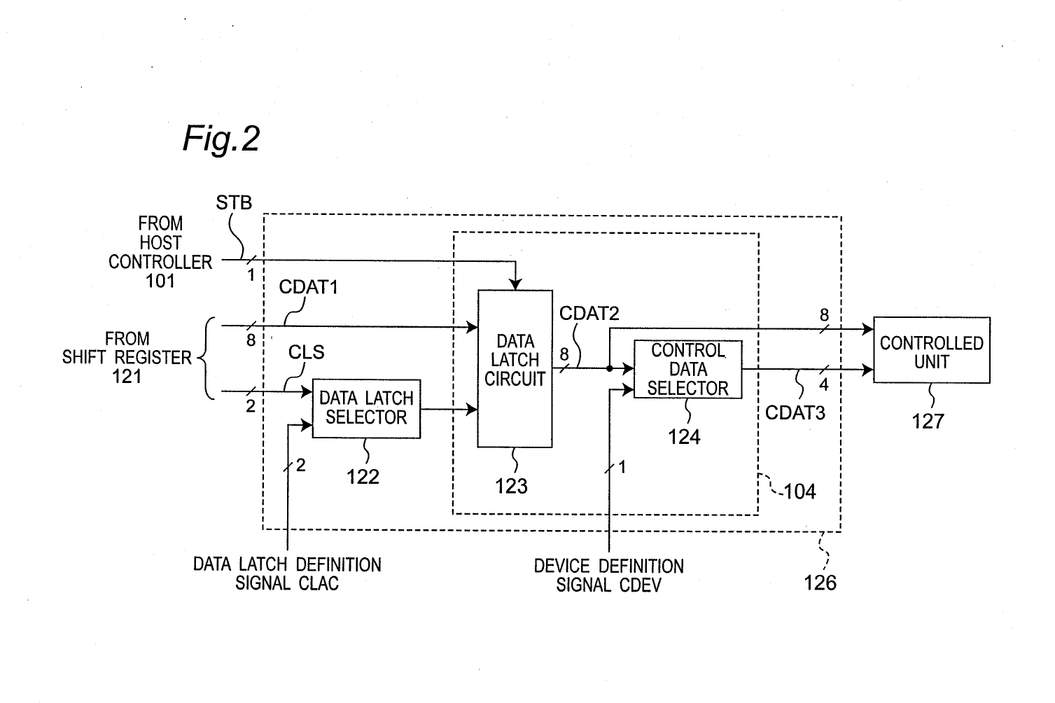

FIG. 2 is a block diagram showing a detailed configuration of each data control circuit 126 of the communication control circuit 102 of FIG. 1. Referring to FIG. 2, the data control circuit 126 is configured to include a data latch selector 122 and a data selector 104. The data selector 104 is configured to include a data latch circuit 123 and a control data selector 124. The data latch selector 122 outputs a selection signal for controlling data to be latched in the data latch circuit 123, according to the 2-bit latch selection signal CLS from the shift register 121 and a 2-bit data latch definition signal CLAC. In this case, the 2-bit data latch definition signal CLAC is defined in the communication control circuit 102 and preset to identify the controlled unit 127. The data latch circuit 123 latches the control signal CDAT1 according to the 8-bit control signal CDAT1 from the shift register 121, the strobe signal STB from the host controller 101, and the selection signal from the data latch selector 122. The control signal latched by the data latch circuit 123 is outputted to the control data selector 124 and the controlled unit 127 as an 8-bit control signal CDAT2. The control data selector 124 selects predetermined four bits from the eight bits of the control signal CDAT2 outputted from the data latch circuit 123, according to a 1-bit device definition signal CDEV, and outputs an output control signal CDAT3 including the selected four bits to the controlled unit 127 to control the same unit. In this case, the 1-bit device definition signal CDEV is generated in an external controller of the communication control circuits 102 and 103, and preset to identify the communication control circuits 102 and 103. It is noted that the device definition signal CDEV indicates the communication control circuit 102 when it is “0”, and indicates the communication control circuit 103 when it is “1”. In addition, each data control circuit 126 of the communication control circuit 103 is different from each data control circuit 126 of the communication control circuit 102 in that each data control circuit 126 of the communication control circuit 103 is connected to the shift register 131 instead of the shift register 121. However, since the other points are similar to each other, no description is provided for them.

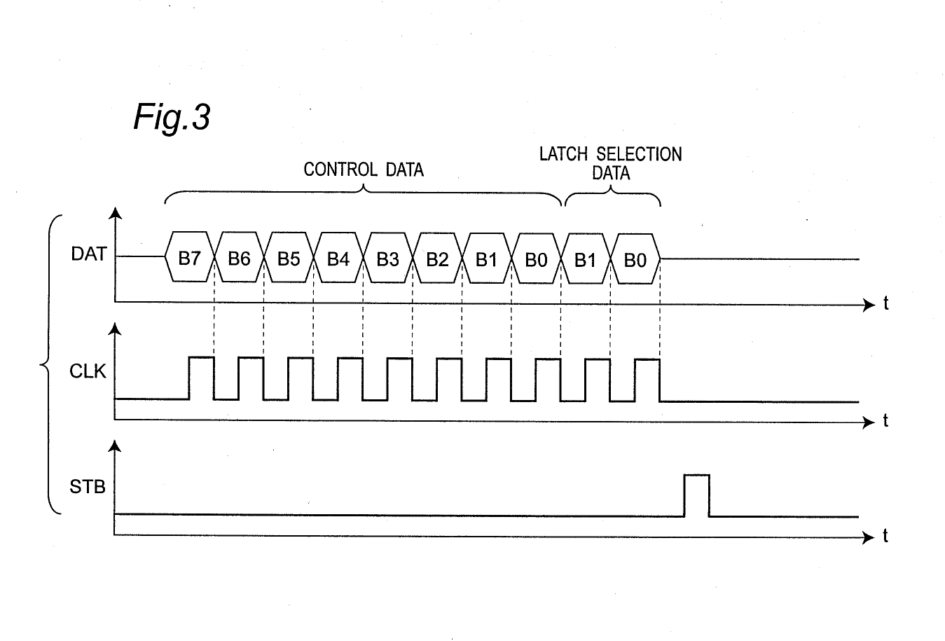

FIG. 3 is a timing chart showing the signals transmitted to the communication control circuits 102 and 103 of FIG. 1. Referring to FIG. 3, the data signal DAT includes a 10-bit signal configured to include 8-bit control data B7 to B0 and 2-bit latch selection data B1 and B0. The clock signal CLK rises at the timings roughly at the centers of the respective data where the data signal DAT does not change. The strobe signal STB is transmitted after a predetermined period after the transmission of the data signal DAT to the communication control circuits 102 and 103 by the host controller 101 is completed.

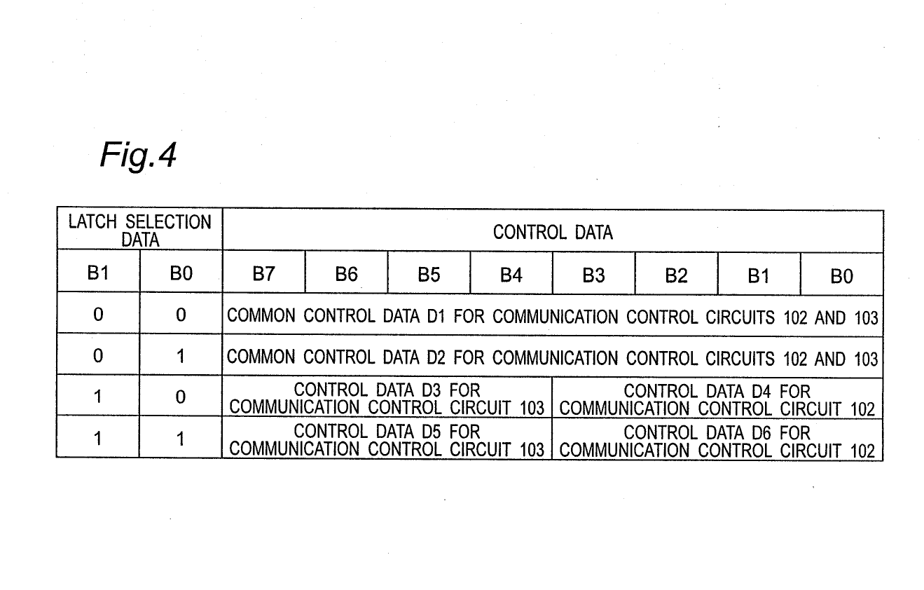

FIG. 4 is a table showing one example of a configuration of the data signal DAT of FIG. 3. Referring to FIG. 4, when both of the bits B1 and B0 of the latch selection data are “0”, control data D1 common for the communication control circuits 102 and 103 is stored in the bits B7 to B0 of the control data, and the controlled units 127-1 and 127-5 are controlled in common. When the bit B1 of the latch selection data is “0” and the bit B0 is “1”, control data D2 common for the communication control circuits 102 and 103 is stored in the bits B7 to B0 of the control data, and the controlled units 127-2 and 127-6 are controlled in common. When the bit B1 of the latch selection data is “1” and the bit B0 is “0”, control data D3 for the communication control circuit 103 is stored in the bits B7 to B4 of the control data, and control data D4 for the communication control circuit 102 is stored in the bits B3 to B0 of the control data. In this case, the controlled unit 127-7 is controlled by the control data D3, and the controlled unit 127-3 is controlled by the control data D4. When both of the latch selection data B1 and B0 are “1”, control data D5 for the communication control circuit 103 is stored in the bits B7 to B4 of the control data, and control data D6 for the communication control circuit 102 is stored in the bits B3 to B0 of the control data. In this case, the controlled unit 127-8 is controlled by the control data D5, and the controlled unit 127-4 is controlled by the control data D6.

Accordingly, the controlled units 127 connected to the communication control circuits 102 and 103 are controlled in common by the control data when the latch selection data is “00” or “01”, and the controlled units 127 connected to the communication control circuits 102 and 103 are individually controlled by the control data when the latch selection data is “10” or “11”. By this operation, it is possible to simultaneously control the respective controlled units 127 connected to the communication control circuits 102 and 103 by the one-time serial data communication.

For example, in the case where the control data does not have any control data for enabling the individual control of a plurality of controlled units 127, such as in the serial communication using the I²C bus, it is required to perform serial data communications two or more times to control communication control circuits 102 and 103 individually, and the communication time for the serial communication is increased by two times or more.

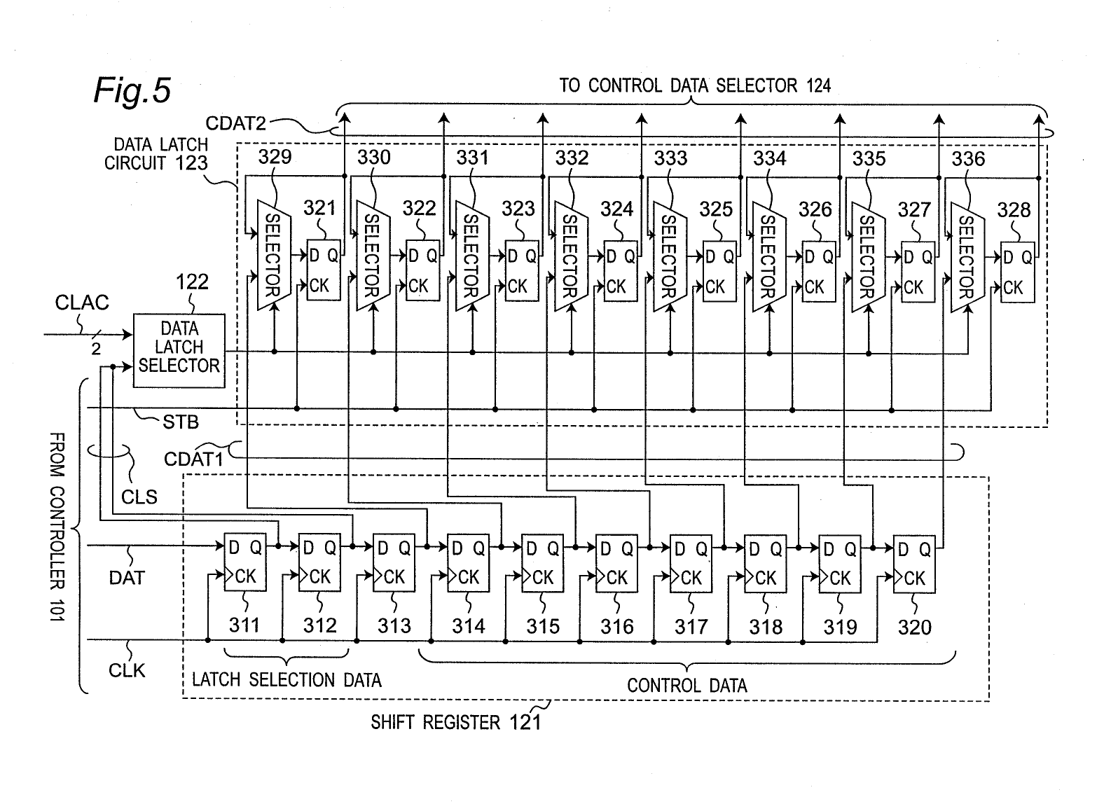

FIG. 5 is a block diagram showing a detailed configurations of the shift register 121 of the communication control circuit 102 of FIG. 1 and the data latch selector 122 and the data latch circuit 123 of FIG. 2. Referring to FIG. 5, the data latch selector 122 and the data latch circuit 123 are the data latch selector 122 and the data latch circuit 123 provided in any one of the data control circuits 126-1 to 126-4 of the communication control circuit 102 of FIG. 1. The data latch selector 122 and the data latch circuit 123 provided in the other data control circuits are connected to the shift register 121 in a manner similar to that of FIG. 2, however, they are omitted here for simplicity of explanation. In addition, the communication control circuit 103 has a configuration similar to that of the communication control circuit 102, except that the shift register 131 is provided in stead of the shift register 121. Referring to FIG. 5, the shift register 121 is configured to include ten delayed flip-flop circuits (referred to as D-FFs hereinafter) 311 to 320 connected in tandem corresponding to the bit number of the transmitted data signal DAT.

The shift register 121 takes in the data signal DAT from the host controller 101 by sequentially shifting the data signal DAT by the D-FFs 311 to 320 based on the clock signal CLK to perform the serial-to-parallel conversion, and thereafter outputs output signals of the D-FFs 311 and 312 to the data latch selector 122 as the 2-bit latch selection signal CLS and outputs output signals of the D-FFs 313 to 320 to the data latch circuit 123 as the 8-bit control signal CDAT1.

The data latch circuit 123 is configured to include D-FFs 321 to 328 and selectors 329 to 336. When all the bits of the data signal DAT are taken into the shift register 121, the strobe signal STB is then inputted from the host controller 101. The control signal CDAT1 of the signals taken in the shift register 121 is taken into respective Q output terminals of the D-FF circuits 321 to 328 of the data latch circuit 123 at a rising edge of the strobe signal STB as a trigger. In this case, comparison between the data latch definition signal CLAC and the latch selection signal CLS is performed by the data latch selector 122. For example, in the case where the data latch selector 122 and the data latch circuit 123 exist in the data control circuit 126 connected to the controlled unit 127 corresponding to the latch selection data “11”, it is determined that the address match occurs when the latch selection signal CLS is “11”, and the data latch selector 122 outputs a signal for controlling the selectors 329 to 336 so that Q output terminals of the D-FF circuits 313 to 320 of the shift register 121 are connected to the D input terminals of the D-FF circuits 321 to 328. By this operation, the control signal CDAT1 of the shift register 121 is taken in and held in the data latch circuit 123. It is determined that the address match does not occur except when the latch selection signal CLS is “11”, and the data latch selector 122 outputs a signal for controlling the selectors 329 to 336 so that the Q output terminals of the D-FF circuits 321 to 328 are selected at the D input terminals of the D-FF circuits 321 to 328. In this case, the control signal CDAT1 of the shift register 121 is not taken into the data latch circuit 123 even when the strobe signal STB is inputted, and the previous control data continues being held.

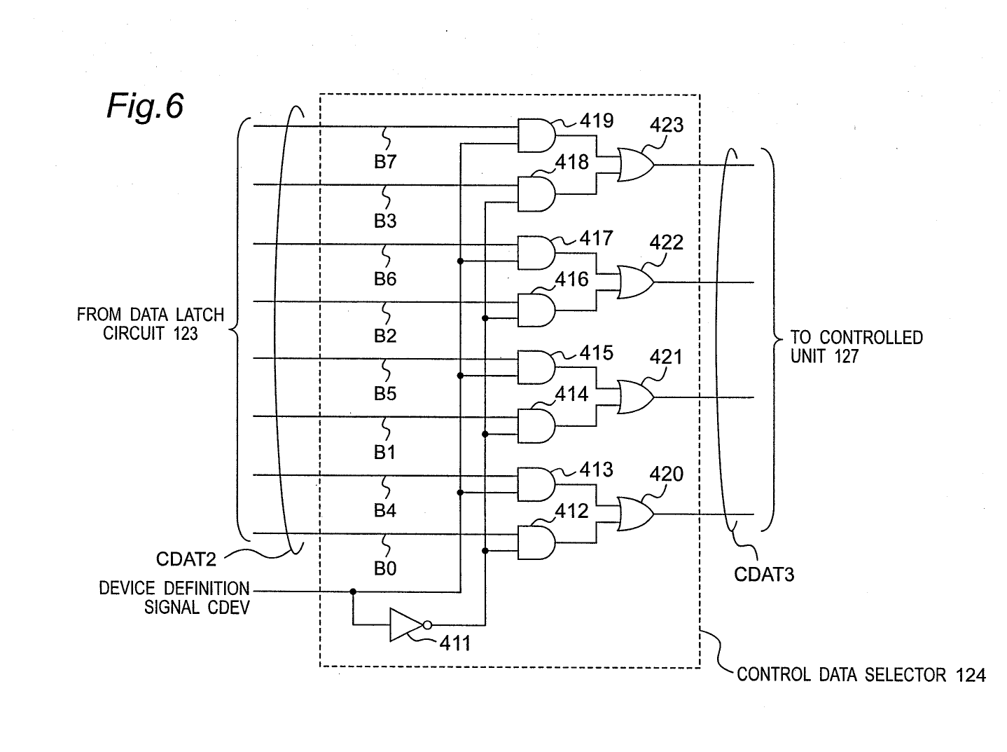

FIG. 6 is a circuit diagram showing a detailed configuration of the control data selector 124 of FIG. 2. Referring to FIG. 6, the control data selector 124 is configured to include AND gates 412 to 419, OR gates 420 to 423, and a NOT gate 411. A corresponding bit of the control signal CDAT2 from the data latch circuit 123 is inputted to one input terminal of each of the AND gates 412, 414, 416 and 418, and the device definition signal CDEV is inputted to another input terminal thereof via the NOT gate 411. A corresponding bit of the control signal CDAT2 from the data latch circuit 123 is inputted to one input terminal of each of the AND gates 413, 415, 417 and 419, and the device definition signal CDEV is inputted to another input terminal thereof. Output signals of the AND gates 412 and 413 are inputted to input terminals of the OR gate 420, output signals of the AND gates 414 and 415 are inputted to input terminals of the OR gate 421, output signals of the AND gates 416 and 417 are inputted to input terminals of the OR gate 422, and output signals of the AND gates 418 and 419 are inputted to the input terminals of the OR gates 423.

For example, when the device definition signal CDEV is “0” indicating the communication control circuit 102 in the control data selector 124, an output control signal CDAT3 equivalent to the bits B0 to B3 of the control signal CDAT2 is outputted from the control data selector 124, and the other bits B4 to B7 of the control signal CDAT2 are discarded. In a manner similar the above, when the device definition signal CDEV is “1” indication the communication control circuit 103, an output control signal CDAT3 equivalent to the bits B4 to B7 of the control signal CDAT2 is outputted, and the other bits B0 to B3 of the control signal CDAT2 are discarded.

Therefore, it is possible to select arbitrary bits of the control signal CDAT2 according to the device definition signal CDEV. Accordingly, by storing the control data of the controlled unit 127 connected to the communication control circuit 102 into the bits B0 to B3 of the control signal CDAT2 and storing the control data of the controlled unit 127 connected to the communication control circuit 103 into the bits B4 to B7 of the control signal CDAT2, it is possible to simultaneously control the controlled units 127 connected to the communication control circuits 102 and 103 by the one-time serial data communication.

As shown in FIG. 2, the 8-bit control signal CDAT2 before being selected by the control data selector 124 is also inputted to the controlled unit 127, and the controlled units 127 may be controlled in common by the 8-bit control signals CDAT2.

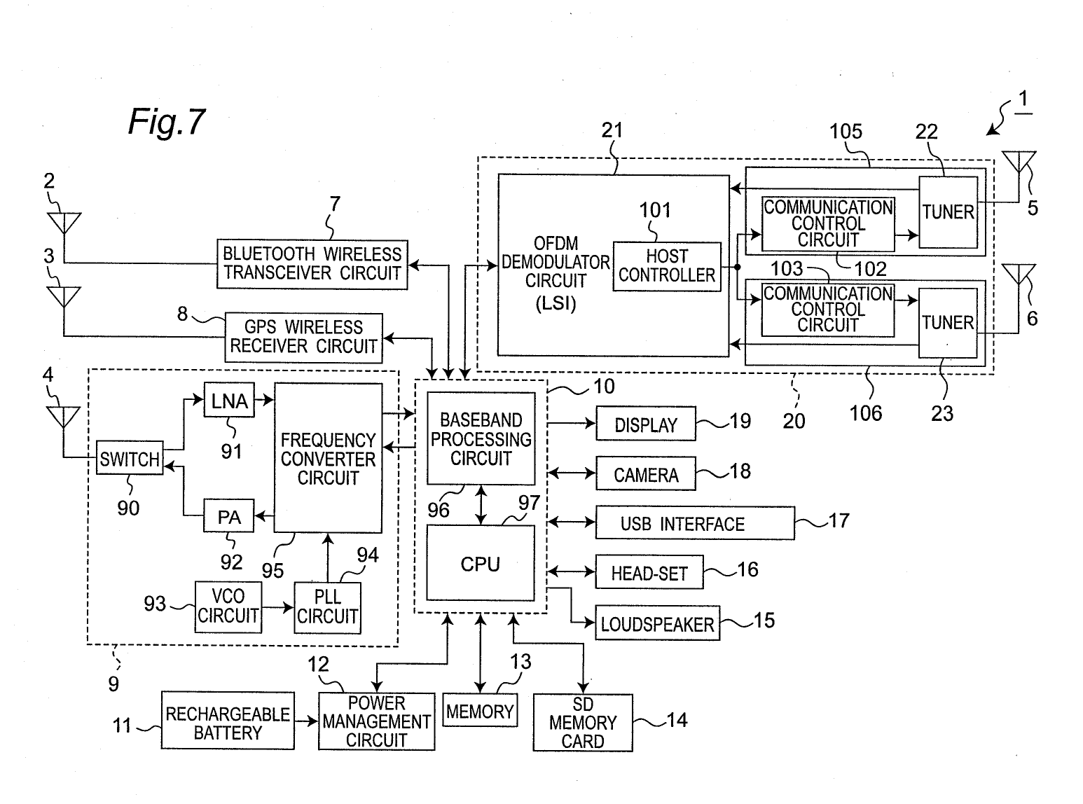

FIG. 7 is a block diagram showing a configuration of a mobile phone 1 employing the communication system of FIG. 1. Referring to FIG. 7, the mobile phone 1 is configured to include antennas 2 to 6, a Bluetooth wireless transceiver circuit, a GPS (Global Positioning System) wireless receiver circuit 8, a video and audio wireless transceiver circuit 9, a control section 10, a rechargeable battery 11, a power management circuit 12, a memory 13, an SD (Secure Digital) memory card 14, a loudspeaker 15, a head-set 16, a USB (Universal Serial Bus) interface 17, a camera 18, a display 19, and a tuner circuit 20. The video and audio wireless transceiver circuit 9 is configured to include a switch 90, a low noise amplifier (LNA: Low Noise Amplifier) 91, a power amplifier (PA: Power Amplifier) 92, a voltage controlled oscillator (VCO: Voltage Controlled Oscillator) circuit 93, a phase locked loop (PLL: Phase Locked Loop) circuit 94, and a frequency converter circuit 95. The control section 10 is configured to include a baseband processing circuit 96 and a CPU 97. The tuner circuit 20 is configured to include an OFDM (Orthogonal Frequency Division Multiplexing) demodulator circuit 21 and tuners 22 and 23.

The control section 10 transmits and receives data based on the Bluetooth standard via the Bluetooth wireless transceiver circuit 7 and the antenna 2, receives the GPS data from a GPS satellite via the GPS wireless receiver circuit 8 and the antenna 3, and transmits and receives video data and audio data via the video and audio wireless transceiver circuit 9 and the antenna 4. The wirelessly received video data and audio data are outputted to the display 19 and the loudspeaker 15, respectively.

The control section 10 is supplied with power from the rechargeable battery 11 via the power management circuit 12. The memory 13 stores, for example, data of an address book or the like. The SD memory card 14 is a detachably attached external memory. In addition, the mobile phone 1 can take a picture by the camera 18. The mobile phone 1 is also usable with the detachable head-set 16 connected thereto and connectable to another apparatus via the USB interface 17.

In the tuner circuit 20, the tuner IC chip 105 is configured to include the tuner 22 and the communication control circuit 102, and the tuner IC chip 106 is configured to include the tuner 23 and the communication control circuit 103. The OFDM demodulator circuit 21 is configured to include the host controller 101. The tuners 22 and 23 may have, for example, a low noise amplifier for amplifying a weak signal inputted to the antennas 5 and 6, a mixer for performing frequency conversion, a filter for removing undesired frequency components, an oscillator for generating a local oscillation signal for performing frequency conversion, a phase locked loop circuit for making the local oscillation signal stably operate, and so on. The OFDM demodulator circuit 21 is formed on one IC chip. The communication control circuits 102 and 103 operate as described above according to signals from the CPU 97 of the control section 10 via the host controller 101 of the OFDM demodulator circuit 21, and controls the controlled units provided in each of the tuners 22 and 23, respectively.

As described above, the communication control circuit of the present embodiment has the control data selector 124 which selects the control signal CDAT3 for controlling the corresponding controlled unit 127, from the control signal CDAT1 after the parallel conversion outputted from the shift register 121, and outputs the control signal CDAT3. Accordingly, it is possible to simultaneously control the plurality of controlled units 127 by the one-time serial data communication. Therefore, it is possible to shorten the communication time for serial communication without increasing the number of the wirings of the serial signal lines by using the signals inputted from the host controller 101 via the three serial signal lines.

In addition, there are provided the data latch selector 122 for comparing the latch selection signal CLS with the data latch definition signal CLAC, and the data latch circuit for holding the control signal CDAT1 from the shift register 121 and outputting the same signal to the control data selector 124 based on the strobe signal STB when the latch selection signal CLS and the inputted data latch definition signal CLAC coincide with each other. Accordingly, it is possible to control the plurality of controlled units 127 connected to the communication control circuits 102 and 103 according to the data latch definition signal CLAC.

In the present embodiment, the two communication control circuits 102 and 103 are connected to the host controller 101. However, the present invention is not limited to a configuration, and three or more communication control circuits may be connected to the host controller 101.

In addition, the transmitted data signal DAT includes the 8-bit control data and the 2-bit latch selection data, however, the bit number of each data is not limited to this. In this case, assuming that the device definition signal CDEV has “n” (“n” is a natural number) bits and the transmitted control data has “m” (where m≧k×2n: k=1, 2, 3, . . . ) bits, “k” controlled units 127 can be simultaneously controlled by 2n communication control circuits by one-time serial data communication. In addition, the data structures of the respective latch selection data exemplified in FIG. 4 are mere examples, and the latch selection data may have other data structures.

Further, the triggering edges of the clock signal CLK and the strobe signal STB, which become the triggers of the D-FF circuits 311 to 320 of the shift register 121, may be the falling edges thereof in stead of the rising edge thereof. In this case, the clock signal CLK and the strobe signal STB should fall down at the timings roughly at the centers of the respective data where the data signal DAT does not change.

### INDUSTRIAL APPLICABILITY

As described above, each of the communication control circuit and method, and the communication system and the electronic apparatus employing the same communication system according to the present invention has control data selector means for selecting and outputting the control data for controlling the corresponding controlled unit from the converted data signal from the shift register, in response to the inputted device definition signal for identifying the communication control circuit. Accordingly, it is possible to shorten the communication time for serial communication without increasing the number of the wirings of the serial signal lines by using signals inputted from host controller means via three serial signal lines.

The communication control circuit and method, and the communication system and the electronic apparatus employing the communication system of the present invention can be utilized in, for example, a mobile phone or the like.

1-6. (canceled)

7. A communication control circuit for controlling a plurality of controlled units according to a data signal, a clock signal and a strobe signal inputted via three serial signal lines,
wherein the data signal includes control data for controlling at least one of the plurality of controlled units, and
wherein the communication control circuit comprises:
a shift register for sequentially taking in the data signal according to the clock signal, serial-to-parallel converting the data signal into a converted data signal, and outputting the converted data signal; and
a control data selector for selecting and outputting control data for controlling a corresponding controlled unit from the converted data signal from the shift register, in response to an inputted device definition signal for identifying the communication control circuit.

8. The communication control circuit as claimed in claim 7,
wherein the data signal further includes latch selection data, and
wherein the communication control circuit further comprises:
a data latch selector for comparing the latch selection data with an inputted data latch definition signal for identifying the controlled units, and outputting a signal indicating a comparison result; and
a data latch circuit for (a) holding the control data of the converted data signal from the shift register and outputting the control data to the control data selector based on the inputted strobe signal when the signal indicating the comparison result indicates that the latch selection data and the inputted data latch definition signal coincide with each other, and (b) stopping holding the control data of the converted data signal from the shift register when the signal indicating the comparison result indicates that the latch selection data and the inputted data latch definition signal do not coincide with each other.

9. A communication control system having at least one communication control circuit each controlling a plurality of controlled units according to a data signal, a clock signal and a strobe signal inputted via three serial signal lines,
wherein the communication control system comprises a host controller for generating the data signal, the clock signal and the strobe signal, and transmitting the data signal, the clock signal and the strobe signal to the plurality of communication control circuits via the three serial signal lines,
wherein the data signal includes control data for controlling at least one of the plurality of controlled units, and
wherein each of the communication control circuits comprises:
a shift register for sequentially taking in the data signal according to the clock signal, serial-to-parallel converting the data signal into a converted data signal, and outputting the converted data signal; and
a control data selector for selecting and outputting control data for controlling a corresponding controlled unit from the converted data signal from the shift register, in response to an inputted device definition signal for identifying the communication control circuits.

10. An electronic apparatus comprising a communication control system having at least one communication control circuit each controlling a plurality of controlled units according to a data signal, a clock signal and a strobe signal inputted via three serial signal lines,
wherein the communication control system comprises a host controller for generating the data signal, the clock signal and the strobe signal, and transmitting the data signal, the clock signal and the strobe signal to the plurality of communication control circuits via the three serial signal lines,
wherein the data signal includes control data for controlling at least one of the plurality of controlled units, and
wherein each of the communication control circuits comprises:
a shift register for sequentially taking in the data signal according to the clock signal, serial-to-parallel converting the data signal into a converted data signal, and outputting the converted data signal; and
a control data selector for selecting and outputting control data for controlling a corresponding controlled unit from the converted data signal from the shift register, in response to an inputted device definition signal for identifying the communication control circuits.

11. A communication control method for use in a communication control circuit for controlling a plurality of controlled units according to a data signal, a clock signal and a strobe signal inputted via three serial signal lines,
wherein the data signal includes control data for controlling at least one of the plurality of controlled units, and
wherein the communication control method includes the following steps of:
sequentially taking in the data signal according to the clock signal, serial-to-parallel converting the data signal into a converted data signal, and outputting the converted data signal; and
selecting and outputting control data for controlling a corresponding controlled unit from the converted data signal, in response to an inputted device definition signal for identifying the communication control circuit.

12. The communication control method as claimed in claim 11,
wherein the data signal further includes latch selection data, and
wherein the communication control method further includes the following steps of:
comparing the latch selection data with an inputted data latch definition signal for identifying the controlled units, and outputting a signal indicating a comparison result;
holding the control data of the converted data signal and outputting the control data based on the inputted strobe signal when the signal indicating the comparison result indicates that the latch selection data and the inputted data latch definition signal coincide with each other; and
stopping holding the control data of the converted data signal when the signal indicating the comparison result indicates that the latch selection data and the inputted data latch definition signal do not coincide with each other.

13. The communication control system as claimed in claim 9,
wherein the data signal further includes latch selection data, and
wherein each of the communication control circuits further comprises:
a data latch selector for comparing the latch selection data with an inputted data latch definition signal for identifying the controlled units, and outputting a signal indicating a comparison result; and
a data latch circuit for (a) holding the control data of the converted data signal from the shift register and outputting the control data to the control data selector based on the inputted strobe signal when the signal indicating the comparison result indicates that the latch selection data and the inputted data latch definition signal coincide with each other, and (b) stopping holding the control data of the converted data signal from the shift register when the signal indicating the comparison result indicates that the latch selection data and the inputted data latch definition signal do not coincide with each other.

14. The electronic apparatus as claimed in claim 10,
wherein the data signal further includes latch selection data, and
wherein each of the communication control circuits further comprises:
a data latch selector for comparing the latch selection data with an inputted data latch definition signal for identifying the controlled units, and outputting a signal indicating a comparison result; and
a data latch circuit for (a) holding the control data of the converted data signal from the shift register and outputting the control data to the control data selector based on the inputted strobe signal when the signal indicating the comparison result indicates that the latch selection data and the inputted data latch definition signal coincide with each other, and (b) stopping holding the control data of the converted data signal from the shift register when the signal indicating the comparison result indicates that the latch selection data and the inputted data latch definition signal do not coincide with each other.
